(19) United States
(12) Patent Application Publication
(10) Pub. No.: US 2012/0010737 A1
(43) Pub. Date: Jan. 12, 2012

(54) AUDIO ADJUSTING DEVICE

(75) Inventors: Kei Sakagami, Kanagawa (JP); Shiro Suzuki, Kanagawa (JP)

(73) Assignee: PIONEER CORPORATION, Kanagawa (JP)

(21) Appl. No.: 13/255,789

(22) PCT Filed: Mar. 16, 2009
(86) PCT No.: PCT/JP2009/055036

§ 371 Date: Sep. 28, 2011

(51) Int. Cl. G06F 17/00

(52) U.S. Cl. 700/94

(57) ABSTRACT

The audio adjusting device is preferable applied to an audio system, and includes an audio analyzing unit, a control unit and an adjusting unit. The audio analyzing unit analyzes audio based on the inputted audio signals on the real time basis. The control unit generates the control signal for adjusting the audio signals based on the analysis information of the audio analyzed by the analyzing unit and the volume level instructed by the user. The adjusting unit adjusts and outputs the audio signals based on the control signal in terms of at least one of spreading feeling, speech clearness and bass volume feeling. The control unit varies the adjusting amount by the adjusting unit based on the signal level of the audio signals and the volume level.

### TECHNICAL FIELD

The present invention relates to an audio adjusting device which adjusts audio in an audio system having a plurality of speakers.

### BACKGROUND TECHNIQUE

In an audio system having a plurality of speakers and creating a sound space of high quality, it is required to automatically create an appropriate sound space with presence, more specifically to impressively present users with sound expressed by a sound creator. Here, in order to reproduce sound expressed by a sound creator, listening with volume level 0 dB is recommended in a case of an AV amplifier approved by THX (Registered Trademark). However, such volume is too large in an actual home theater environment, and the listening with the volume smaller than 0 dB is the reality. Therefore, in the home theater environment, the impression may be different from the sound that the sound creator intended.

In this view, the following Patent Reference-1 discloses a method of emphasizing reflected sound when the volume is lowered by the audio adjusting device and emphasizing the low and high ranges of the frequency characteristic of the sound audible to a human being, thereby performing audio reproduction with presence even with small volume. Also, Patent Reference-2 discloses a method of obtaining type information from header information of management information file or contents data file, and automatically setting a value associated with the type information to the sound quality/sound field adjusting means which applies sound quality adjustment and/or sound effect.

Patent Reference-1: Japanese Patent Application Laid-open under No. H09-65496

Patent Reference-2: Japanese Patent Application Laid-open under No. 2006-108843

### DISCLOSURE OF INVENTION

### Problem to be Solved by the Invention

By the way, by the method described in the Patent Reference-1, the reflected sound and/or the frequency characteristic is adjusted in accordance with the volume adjustment by the volume adjusting device, i.e., in accordance with the volume level instructed by the user. Therefore, in the case where the input signal level is large and the volume level is low, the reflected sound and/or the frequency characteristic is adjusted, and hence there is a possibility that excessive sound effect is provided. In addition, in the case where the input signal level is small and the volume level is high, the reflected sound and/or the frequency characteristic is not adjusted, and hence there is a possibility that the presence is lost . On the other hand, by the method described in the Patent Reference-2, since the same setting value is always applied in the same contents, it is difficult to perform adjustment in accordance with scenes in the same contents.

The above is an example of a problem to be solved by the present invention. It is an object of the present invention to provide an audio adjusting device capable of adjusting the sound to impressively present the user with the sound expressed by the sound creator and to create the presence.

### Means for Solving the Problem

The invention according to claim 1 is an audio adjusting device including: an audio analyzing unit which analyses audio based on inputted audio signals on a real time basis; a control unit which generates control signals for adjusting the audio signals based on analysis information analyzed by the audio analyzing unit and a volume level instructed by a user; and an adjusting unit which adjusts and outputs the audio signals based on the control signals in terms of at least one of spreading feeling, speech clearness and bass volume feeling, wherein the control unit varies an adjusting amount of the audio signals based on a signal level of the audio signals and the volume level.

### BRIEF DESCRIPTION OF THE DRAWINGS

FIG. 1 is a block diagram illustrating a configuration of an audio system including an audio adjusting device according to a first embodiment.

FIG. 2 is a schematic diagram illustrating an example of a listening room.

FIG. 3 is a block diagram illustrating a configuration of a signal processing circuit according to the first embodiment.

FIG. 4 is a block diagram illustrating a configuration of an audio analyzing unit.

FIG. 5 is a block diagram illustrating a configuration of a spreading degree analyzing unit.

FIG. 6 is a block diagram illustrating a configuration of a front-rear balance analyzing unit.

FIG. 7 is a block diagram illustrating a configuration of a speech rate analyzing unit.

FIG. 8 illustrates an example of a frequency characteristic of a filter bank.

FIG. 9 is a block diagram illustrating a configuration of a signal level analyzing unit.

FIG. 10 illustrates graphs illustrating relations between a reproduction volume and an adjusting amount.

FIG. 11 is a block diagram illustrating a configuration of an audio system including an audio adjusting device according to a second embodiment.

FIG. 12 is a block diagram illustrating a configuration of a signal processing circuit in the second embodiment.

FIG. 13 is a block diagram illustrating a configuration of a signal processing circuit in the third embodiment.

FIG. 14 is a block diagram illustrating a configuration of an audio analyzing unit.

FIG. 15 is a block diagram illustrating a configuration of a spreading degree analyzing unit.

FIG. 16 is a block diagram illustrating a configuration of a signal processing circuit according to an application of the third embodiment.

### BRIEF DESCRIPTION OF REFERENCE NUMBERS

21 Audio analyzing unit
22 Control unit
23 Spreading feeling adjusting unit
24 Speech clearness adjusting unit
25 Bass volume feeling adjusting unit

### DETAILED DESCRIPTION OF THE PREFERRED EMBODIMENTS

According to one aspect of the present invention, there is provided an audio adjusting device including: an audio analyzing unit which analyses audio based on inputted audio signals on a real time basis; a control unit which generates control signals for adjusting the audio signals based on analysis information analyzed by the audio analyzing unit and a volume level instructed by a user; and an adjusting unit which adjusts and outputs the audio signals based on the control signals in terms of at least one of spreading feeling, speech clearness and bass volume feeling, wherein the control unit varies an adjusting amount of the audio signals based on a signal level of the audio signals and the volume level.

The above audio adjusting device is preferable applied to an audio system, and includes an audio analyzing unit, a control unit and an adjusting unit. The audio analyzing unit analyzes audio based on the inputted audio signals on the real time basis. The control unit generates the control signal for adjusting the audio signals based on the analysis information of the audio analyzed by the analyzing unit and the volume level instructed by the user. The adjusting unit adjusts and outputs the audio signals based on the control signal in terms of at least one of the spreading feeling, the speech clearness and the bass volume feeling. Here, the control unit varies the adjusting amount by the adjusting unit based on the signal level of the audio signals and the volume level. By this, the sound expressed by a sound creator can be impressively presented to a user, and presence can be created. Particularly, by varying the adjusting amount based on the signal level of the audio signals and the volume level, the sound can be impressively presented to the user, irrespective of the volume with which the actual user listens to the sound.

In a preferred embodiment of the above audio adjusting device, the control unit makes the adjusting amount larger as a reproduction volume calculated by multiplying the signal level of the audio signals by the volume level is smaller.

One mode of the above audio adjusting device further includes a detecting unit which detects illumination of an environment. The control unit generates the control signal based on the illumination detected by the detecting unit, the signal level of the audio signals and the volume level, and the adjusting unit adjusts and outputs the audio signals based on the control signal. By this, the sound can be impressively presented to the user, irrespective of the brightness of the place where the user is present.

In another mode of the above audio adjusting device, the audio analyzing unit calculates spreading degree information indicating spreading degree of the audio in a left-right direction based on a difference between a sum signal of left audio signals and a sum signal of right audio signals, and the control unit generates the control signal for adjusting the audio signals based on the signal level of the audio signals, the volume level and the spreading degree information. By this, the adjusting unit can appropriately adjust the spreading feeling and/or the bass volume feeling.

In another mode of the above audio adjusting device, the audio analyzing unit calculates front-rear balance information indicating a front-rear balance of the audio based on a difference between an average signal of absolute values of front audio signals and an average signal of absolute values of rear audio signals, and the control unit generates the control signal for adjusting the audio signals based on the signal level of the audio signals, the volume level and the front-rear balance information. By this, the adjusting unit can appropriately adjust the balance of the spreading feeling in front-rear direction.

In another mode of the above audio adjusting device, the audio analyzing unit calculates speech rate information indicating a rate of speech in the audio, based on a level of a center audio signal at each frequency band, and the control unit generates the control signal for adjusting the audio signals based on the signal level, the volume level and the speech rate information. By this, the adjusting unit can effectively clarify the speech.

In another mode of the above audio adjusting device, the audio analyzing unit calculates speech rate information indicating a rate of speech based on the spreading degree information, and the control unit generates the control signal for adjusting the audio signals based on the signal level of the audio signals, the volume level and the speech rate information. By this, even in a case where there is no center audio signal, e.g., the audio signals are 2-channels, the adjusting unit can effectively clarify the speech.

### Embodiment

A preferred embodiment of the present invention will be described below with reference to the attached drawings.

### 1st Embodiment

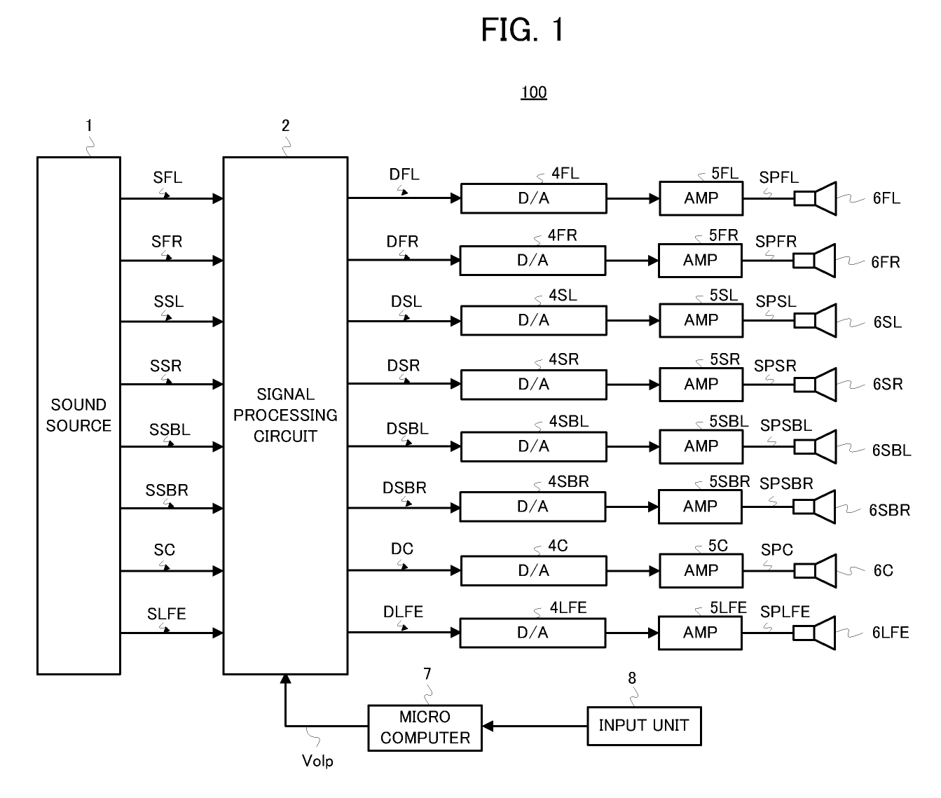

FIG. 1 is a block diagram illustrating an audio system including an audio adjusting device according to the first embodiment.

The audio system 100 is a multi-channel audio system, and includes a signal processing circuit 2 which receives audio signals SFL, SFR, SSL, SSR, SSBL, SSBR, SC, SLFE from a sound source 1 such as a DVD player, a HDD player and a BD player via signal transmission paths of multiple channels. The signal processing circuit 2 is included in an AV amplifier or an AV system having an AV amplifier. The signal processing circuit 2 corresponds to the audio adjusting device according to the present invention.

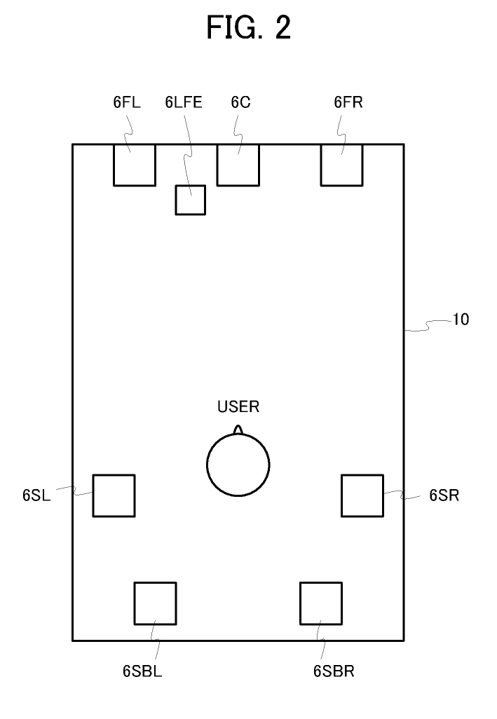

In addition, the audio system 100 includes D/A converters 4FL to 4LFE which convert digital outputs DFL to DLFE, subjected to the signal processing by the signal processing circuit 2 for each channel and outputted, to analog signals, and amplifiers 5FL to 5LFE which amplify each of the analog audio signals outputted by the D/A converters 4FL to 4LFE. The audio system 100 supplies each of the analog audio signals SPFL to SPLFE amplified by the amplifier 5 to speakers 6FL to 6LFE of multiple channels arranged in a listening room 10 exemplarily shown in FIG. 2, and activates the speakers to output sound.

Further, the audio system 100 includes a microcomputer 7 connected to the signal processing circuit 2, and an input unit connected to the microcomputer 7. The input unit 8 is a device operated when a user gives an instruction and/or input to the signal processing circuit 2, and may be various kinds of buttons provided on a front panel of a body of an AV amplifier including the signal processing circuit 2 or a remote controller. For example, when the user instructs the volume level by the input unit 8, the microcomputer 7 outputs a signal of the instructed volume level Volp to the signal processing circuit 2.

Here, the audio system 100 activates the full-range speakers 6FL, 6FR, 6C, 6SL, 6SR having the frequency characteristic capable of reproducing audio over full-range of the audio frequency band, the speaker 6LFE dedicated to the low-range reproduction which has a frequency characteristic for reproducing only so-called deep bass, and the surround back speakers 6SBL and 6SBR arranged behind the user.

More specifically, as the arrangement the speakers for example, the left and right, 2-channel front speakers (the front left speaker and the front right speaker) 6FL, 6FR as well as the center speaker 6C are arranged in front of the user, as shown in FIG. 2. The left and right, 2-channel surround speakers (the rear left speaker and the rear right speaker) 6SL, 6SR and the left and right, 2-channel surround back speakers 6SBL, 6SBR are arranged behind the user, and further the subwoofer 6LFE dedicated to the low-range reproduction is arranged at an arbitrary position. The audio adjusting device provided in the audio system 100 supplies the analog audio signals SPFL to SPLFE, for which the frequency characteristic and/or the signal level of each channel is adjusted, to those eight speakers 6FL to 6LFE to output sound, thereby realizing the sound space with presence.

In the following description, “the audio signals S” indicates the audio signals SFL to SLFE of all channels. Also, in the following description, “the left audio signals” indicates the audio signals SFL, SSL, SSBL outputted to the speakers on the left side of the user, and “the right audio signals” indicates the audio signals SFR, SSR, SSBR outputted to the speakers on the right side of the user. In addition, “the front-side audio signals” indicates the audio signals SFL, SFR, SC outputted to the speakers in front of the user, and “the rear-side audio signals” indicates the audio signals SSL, SSR, SSBL, SSBR outputted to the speakers behind the user.

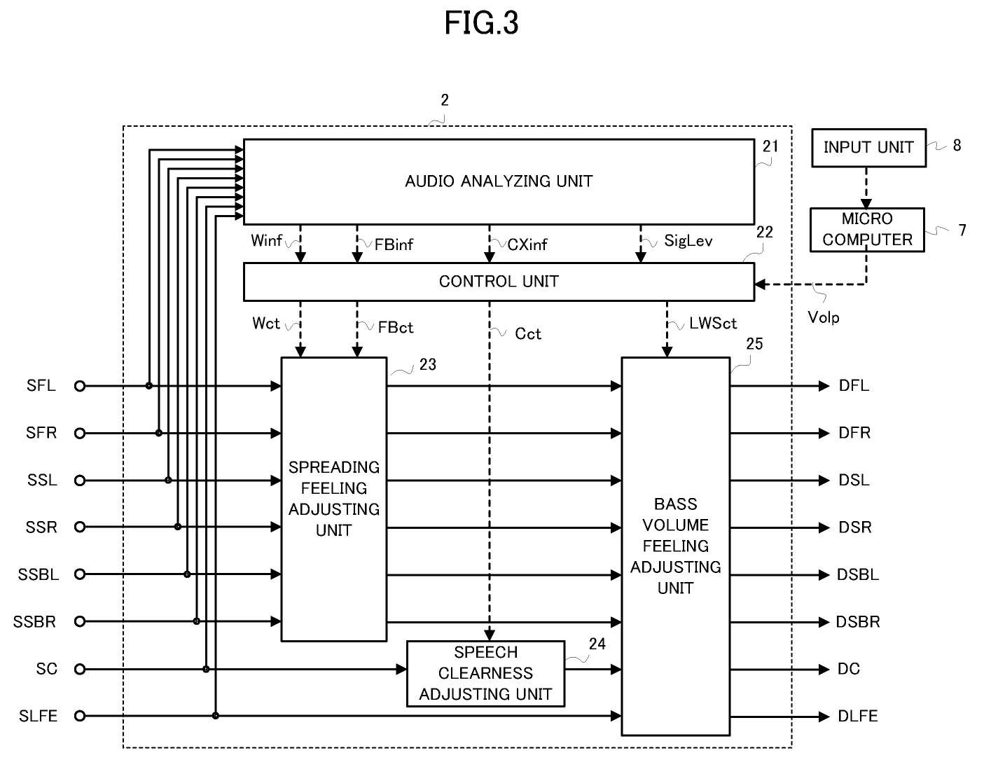

Next, the configuration of the signal processing circuit 2 will be described with reference to FIG. 3. FIG. 3 is a block diagram illustrating the configuration of the signal processing circuit 2. In FIG. 3, the audio signals are shown by the solid lines, and the signals other than the audio signals, such as a control signals, are shown by the broken lines.

The signal processing circuit 2 is formed by a Digital Signal Processor (DSP) and the like, and roughly includes an audio analyzing unit 21, a control unit 22, a spreading feeling adjusting unit 23, a speech clearness adjusting unit 24 and a bass volume feeling adjusting unit 25.

To the audio analyzing unit 21, the audio signals of all channels are inputted from the sound source 1. The audio analyzing unit 21 analyzes the audio based on the inputted audio signals on the real-time basis, and outputs the signal indicating the resultant, various analysis information of the audio to the control unit 22. The analysis information includes spreading degree information Winf indicating the spreading degree of audio, front-rear balance information FBinf indicating audio balance in the front-rear direction of the user, speech rate information CXinf indicating the rate of speech in the audio, and signal level information SigLev indicating the signal level of the audio signals S.

The control unit 22 generates various control signals to adjust the audio signals S based on the various analysis information inputted from the audio analyzing unit 21 and the volume level

Volp inputted from the microcomputer 7, and supplies them to the spreading feeling adjusting unit 23, the speech clearness adjusting unit 24 and the bass volume feeling adjusting unit 25.

Concretely, the control unit 22 generates the spreading feeling control signal Wct for adjusting the spreading feeling of audio based on the spreading degree information Winf, the signal level information SigLev and the volume level Volp, and outputs it to the spreading feeling adjusting unit 23. The control unit 22 generates the front-rear balance control signal FBct for adjusting the balance of the spreading feeling at the front and the rear of the user based on the front-rear balance information FBinf, the signal level information SigLev and the volume level Volp, and outputs it to the spreading feeling adjusting unit 23.

The spreading feeling adjusting unit 23 adjusts the audio signals SFL, SFR, SSL, SSR, SSBL, SSBR in accordance with the spreading feeling control signal Wct to adjust the spreading feeling. As the spreading feeling adjusting process, wide stereo processing and/or reflected sound/reverberation sound adding process may be applied, for example . It is noted that “spreading feeling” here includes “surrounded feeling (so-called surround)”. The spreading feeling adjusting unit 23 adjusts the audio signals SFL, SFR, SSL, SSR, SSBL, SSBR in accordance with the front-rear balance control signal FBct to adjust the balance of the spreading feeling at the front and the rear of the user.

In addition, the control unit 22 generates the speech clearness control signal Cct for adjusting the speech clearness based on the speech rate information CXinf, the signal level information SigLev and the volume level Volp, and outputs it to the speech clearness adjusting unit 24.

The speech clearness adjusting unit 24 adjusts the audio signal SC in accordance with the speech clearness control signal Cct to adjust the clearness of the speech. As the speech clearness adjusting process, a process of adjusting the level of the frequency band corresponding to formant frequency or equalizing may be applied, for example.

Further, the control unit 22 generates the bass volume feeling control signal LWSct for adjusting the bass volume feeling based on the spreading degree information Winf, the signal level information SigLev and the volume level Volp, and outputs it to the bass volume feeling adjusting unit 25.

The bass volume feeling adjusting unit 25 adjusts the audio signals S in accordance with the bass volume feeling control signal LWSct to adjust the bass volume feeling. As the bass volume feeling adjusting process, a process of adjusting the level of the frequency band corresponding to bass or equalizing may be applied, for example.

The audio signals S adjusted by the spreading feeling adjusting unit 23, the speech clearness adjusting unit 24 and the bass volume feeling adjusting unit 25 are outputted as the audio signals DFL to DLFE. Thereafter, the audio signals DFL to DLFE are inputted to the D/A converters 4FL to 4LFE, respectively, as shown in FIG. 1.

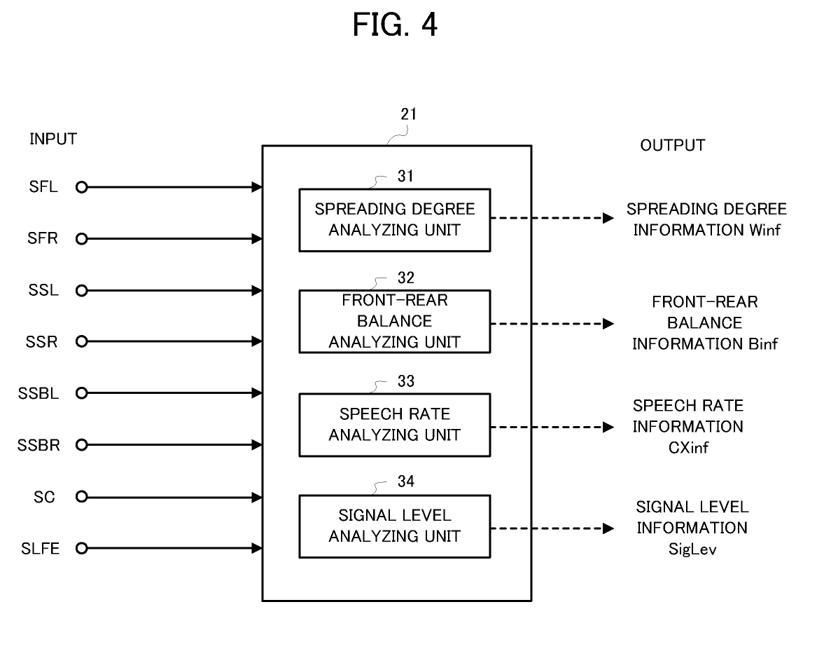

Next, the description will be specifically given of the method of calculating the various analysis information of audio in the audio analyzing unit 21, with reference to FIGS. 4 to 7.

FIG. 4 is a block diagram illustrating the configuration of the audio analyzing unit 21 . The audio analyzing unit 21 includes a spreading degree analyzing unit 31, a front-rear balance analyzing unit 32, a speech rate analyzing unit 33 and a signal level analyzing unit 34. As illustrated in FIG. 4, the spreading degree information Winf is generated by the spreading degree analyzing unit 31, the front-rear balance information FBinf is generated by the front-rear balance analyzing unit 32, the speech rate information CXinf is generated by the speech rate analyzing unit 33, and the signal level information SigLev is generated by the signal level analyzing unit 34.

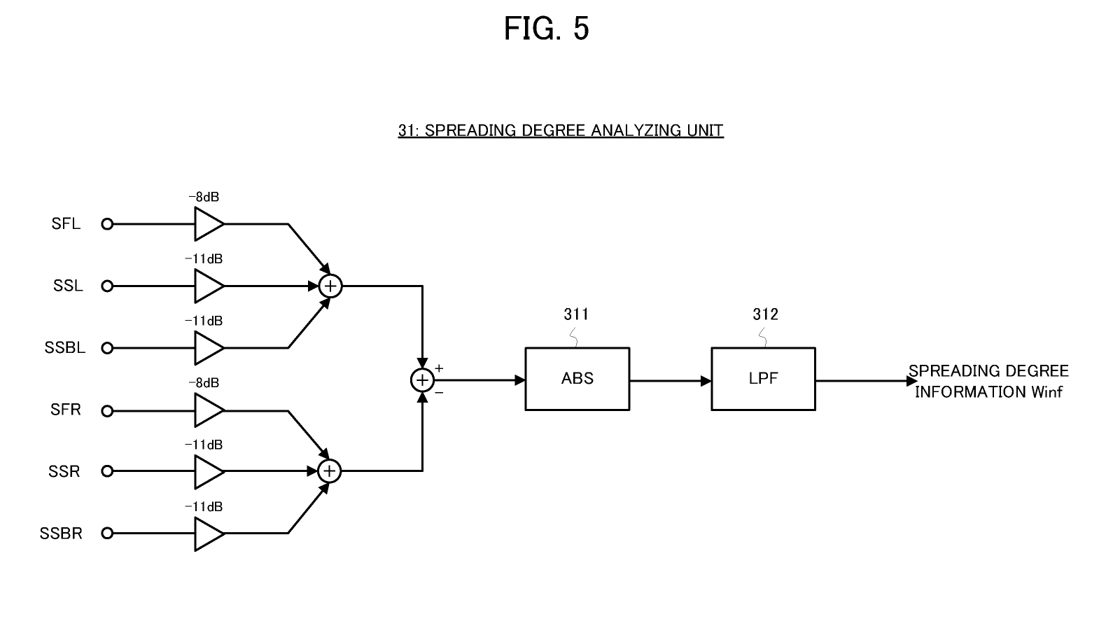

The spreading degree analyzing unit 31 will be described with reference to FIG. 5. FIG. 5 is a block diagram illustrating the spreading degree analyzing unit 31. The spreading degree analyzing unit 31 calculates the spreading degree information Winf based on the difference between the sum signal of the left audio signals SFL, SSL, SSBL and the sum signal of the right audio signals SFR, SSR, SSBR.

More specifically, first the spreading degree analyzing unit 31 weights the left audio signals SFL, SSL, SSBL, respectively, and then adds them (down-mixing) . In the example shown in FIG. 5, the audio signal SFL is weighted by −8 dB and the audio signals SSL, SSBL are weighted by −11 dB, and then they are added to each other. Namely, the front audio signal SFL is weighted by a larger value than the rear audio signals SSL, SSBL. In addition, the spreading degree analyzing unit 31 similarly weights the right audio signals SFR, SSR, SSBR, respectively, and then adds them. Also in this case, similarly to the left audio signals, the front audio signal SFR is weighted by a larger value than the rear audio signals SSR, SSBR.

As shown in FIG. 5, the spreading degree analyzing unit 31 calculates the difference signal between the sum signal of the left audio signals SFL, SSL, SSBL and the sum signal of the right audio signals SFR, SSR, SSBR. Then, the spreading degree analyzing unit 31 inputs the calculated difference signal to the absolute value circuit (ABS) 311 to generate an absolute value, and smoothes the absolute value of the difference signal by the low pas filter 312 and outputs it to the control unit 22 as the signal indicating the spreading degree information Winf.

In this way, the spreading degree information is calculated based on the difference between the sum signal of the left audio signals SFL, SSL, SSBL and the sum signal of the right audio signals SFR, SSR, SSBR. The spreading degree information indicates the spreading degree of audio in the left-right directions. Specifically, as the spreading degree information is large, the spreading degree of audio in the left-right direction is large, and as the spreading degree information is small, the spreading degree of audio in the left-right direction is small.

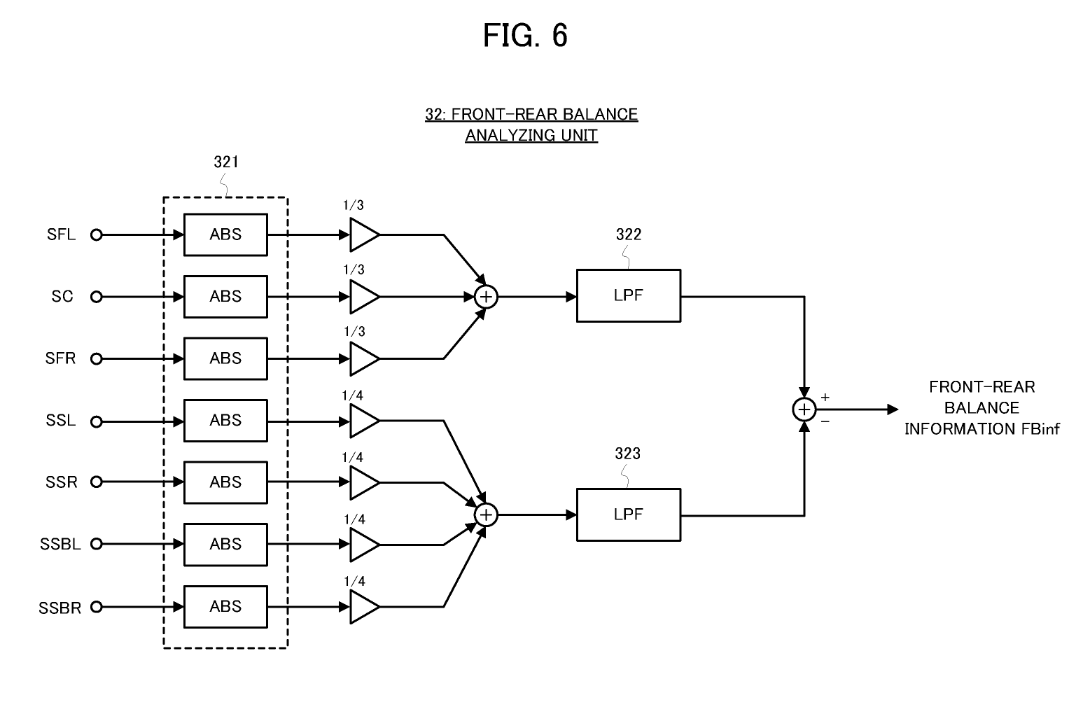

The front-rear balance analyzing unit 32 will be described with reference to FIG. 6. FIG. 6 is a block diagram illustrating the configuration of the front-rear balance analyzing unit 32. The front-rear balance analyzing unit 32 calculates the front-rear balance information FBinf based on the difference between the average signal of the absolute values of the front audio signals SFL, SC, SFR and the average signal of the absolute values of the rear audio signals SSL, SSR, SSBL, SSBR.

More specifically, first the front-rear balance analyzing unit 32 inputs the front audio signals SFL, SC, SFR to the absolute value circuit 321 to calculate their absolute values, respectively, and averages them. For example, since the front audio signals are 3-channels in the example of FIG. 6, the front-rear balance analyzing unit 32 calculates the absolute values of the front audio signals SFL, SC, SFR, and adds them after multiplying them by the coefficient ⅓, respectively. The front-rear balance analyzing unit 32 inputs the rear audio signals SSL, SSR, SSBL, SSBR to the absolute value circuit 321 to calculate their absolute values, respectively, and averages them. For example, since the rear audio signals are 4-channels in the example of FIG. 6, the front-rear balance analyzing unit 32 calculates the absolute values of the rear audio signals SSL, SSR, SSBL, SSBR, and adds them after multiplying them by the coefficient ¼, respectively.

The front-rear balance analyzing unit 32 smoothes the average front audio signal by the low pass filter 322, and smoothes the average rear audio signal by the low pass filter 323. Then, the front-rear balance analyzing unit 32 outputs the difference signal of the smoothed front and rear audio signals to the control circuit 22 as the signal indicating the front-rear balance information FBinf.

In this way, the front-rear balance information FBinf is calculated based on the difference between the average signal of the absolute values of the front audio signals SFL, SC, SFR and the average signal of the absolute values of the rear audio signals SSL,SSR,SSBL,SSBR. The front-rear balance information indicates the balance of audio in the front-rear direction. Specifically, when the front-rear balance information FBinf is positive, the level of the front audio signals is larger than the level of the rear audio signals, and when the front-rear balance information FBinf is negative, the level of the rear audio signals is larger than the level of the front audio signals.

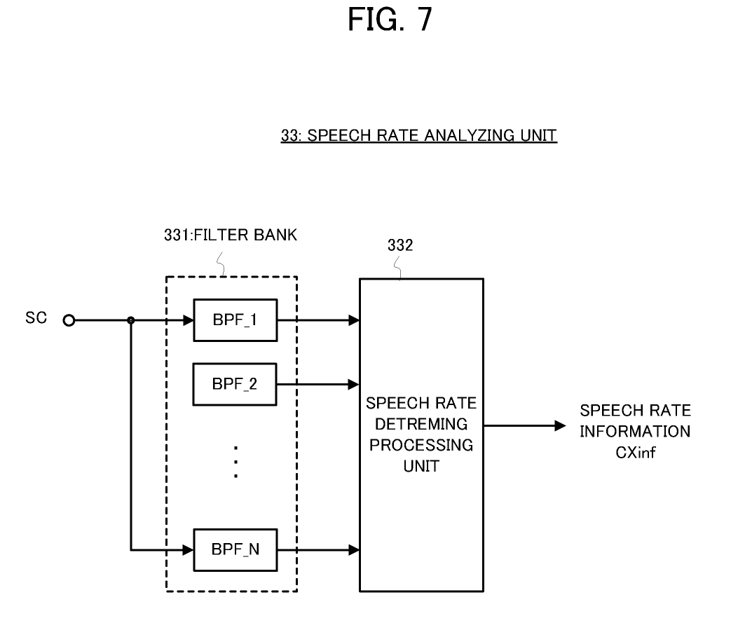

The speech rate analyzing unit 33 will be described with reference to FIG. 7. FIG. 7 is a block diagram illustrating the configuration of the speech rate analyzing unit 33. The speech rate analyzing unit 33 calculates the speech rate information CXinf based on the levels of the plural frequency bands of the center audio signal SC.

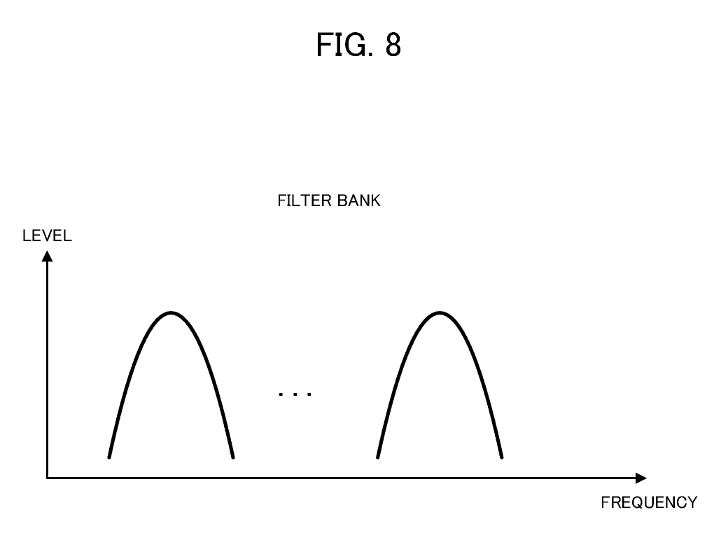

More specifically, the speech rate analyzing unit 33 has a filter bank 331 in which plural band pass filters BPF_1 to BPF_N (N: integer) having the center frequency different from each other are arranged in parallel. The speech rate analyzing unit 33 inputs the center audio signal SC to the filter bank 331, i.e., inputs the center audio signal to the plural band pass filters BPF_1 to BPF_N to calculate the level at each of the plural frequency bands. FIG. 8 illustrates an example of the frequency characteristic of the filter bank 331. As illustrated in FIG. 8, by inputting the center audio signal SC to the filter bank 331, the levels of the center audio signal SC at the plural frequency bands can be detected.

The speech rate determination processing unit 332 calculates the rate of the speech and other background sound based on the level in the frequency bands of the human voice and the level in other frequency bands, and outputs the calculated rate to the control unit 22 as the speech rate information CXinf. In this way, the speech rate information CXinf is calculated based on the levels of the center audio signal SC at the plural frequency bands. As a method of calculating the speech rate information CXinf, instead of using the filter bank, FFT (Fast Fourier Transform) or Generalized Harmonic Analysis may be used.

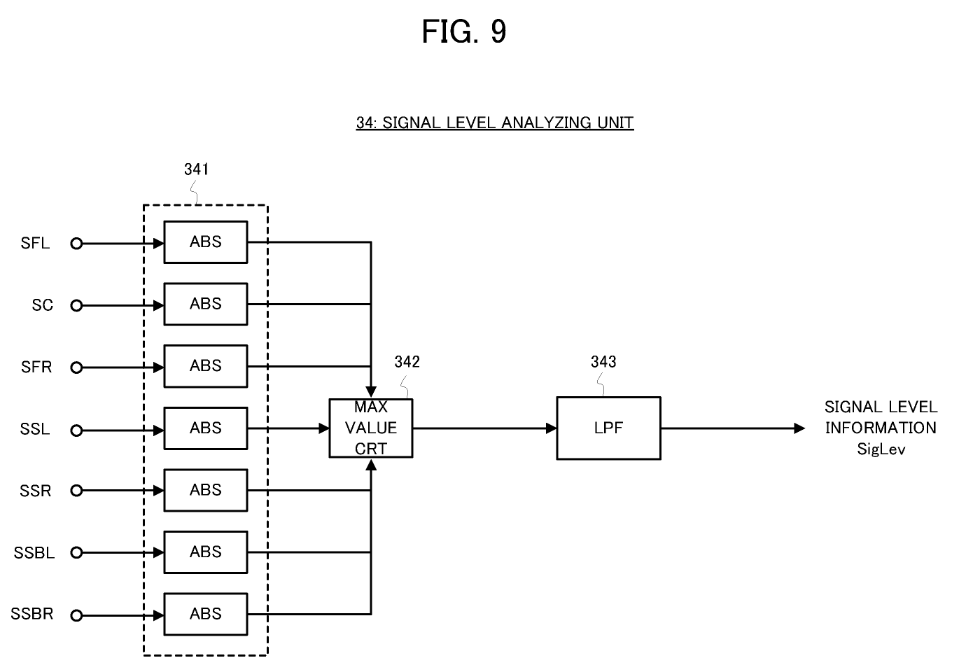

The signal level analyzing unit 34 will be described with reference to FIG. 9. FIG. 9 is a block diagram illustrating the configuration of the signal level analyzing unit 34. The signal level analyzing unit 34 calculates the absolute values of the audio signals SFL, SC, SFR, SSR, SSL, SSBL, SSBR by the absolute value circuit 341, respectively. Then, the signal level analyzing unit 34 inputs those audio signals to the maximum value circuit 342 to determine the signal having the maximum level from those audio signals. Then, the signal level analyzing unit 34 smoothes the signal having the maximum level by the low pass filter 343, and outputs it to the control unit 22 as the signal level information SigLev indicating the signal level of the audio signals S.

Next, the operation in the control unit 22 and the adjusting units 23 to 25 will be described.

As described in the description of FIG. 3, the control unit 22 generates various control signals based on the various analysis information from the audio analyzing unit 21 and the volume level Volp from the microcomputer 7, and outputs them to the adjusting units 23 to 25. The adjusting units 23 to 25 adjust the spreading feeling, the front-rear balance of the spreading feeling, the speech clearness and the bass volume feeling, respectively, in accordance with the various control signals.

First, the adjusting method of the spreading feeling will be described. The control unit 22 generates the spreading feeling control signal Wct including the adjusting amount of the spreading feeling based on the spreading degree information Winf, the signal level information SigLev and the volume level Volp, and outputs it to the spreading feeling adjusting unit 23. The spreading feeling adjusting unit 23 adjusts the audio signals SFL, SFR, SSL, SSR, SSBL, SSBR in accordance with the adjusting amount of the spreading feeling thereby to adjust the spreading feeling.

More specifically, the control unit 22 sets the adjusting amount of the spreading feeling based on the spreading degree information Winf. Concretely, based on the spreading degree information Winf, the control unit 22 sets the adjusting amount of the spreading feeling to be larger as the spreading degree in the left-right direction is larger and sets the adjusting amount of the spreading feeling to be smaller as the spreading degree in the left-right direction is smaller. Here, in order to avoid excessive sound effect, the control unit 22 may set the adjusting amount of the spreading feeling to be smaller as the spreading degree in the left-right direction is larger, when the spreading degree in the left-right direction is larger than a predetermined value.

The control unit 22 varies the adjusting amount of the spreading feeling in accordance with, not only the spreading degree information Winf, but also the signal level information SigLev and the volume level Volp. Concretely, the control unit 22 multiplies the signal level of the audio signals S by the volume level Volp to calculate the reproduction volume which is the volume of the reproduced audio, and varies the adjusting amount of the spreading feeling based on the reproduction volume by using a map indicating the relation between the reproduction volume and the adjusting amount.

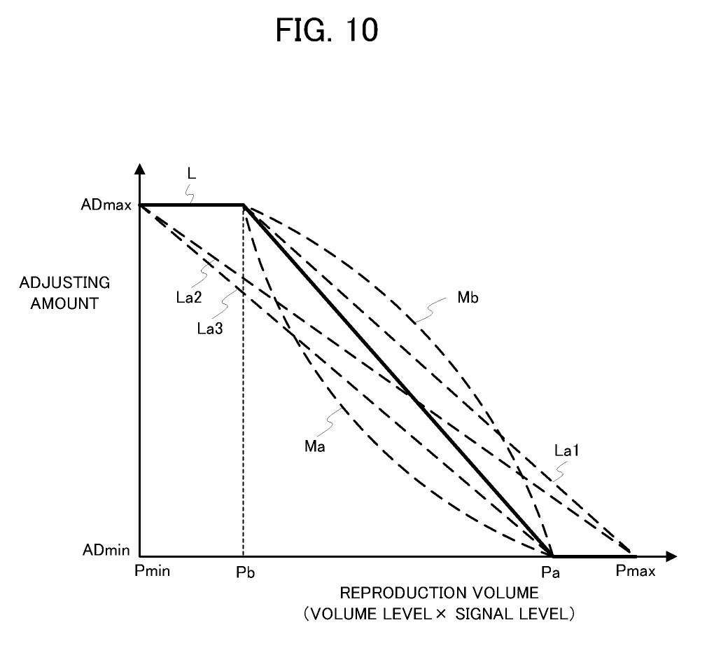

FIG. 10 is a graph illustrating the relation between the reproduction volume and the adjusting amount. Here, “adjusting amount” in FIG. 10 is not only the adjusting amount of the spreading feeling, but also other adjusting amount described later (the adjusting amount of the front-rear balance, the adjusting amount of the speech clearness, etc.).

In the graph L indicated by the solid line in FIG. 10, when the reproduction volume is larger than Pa, the control unit 22 sets the adjusting amount to be the minimum value ADmin, i.e., does not perform the adjustment. When the reproduction volume is larger than Pb and equal to or smaller than Pa, the control unit 22 sets the adjusting amount to be larger as the reproduction volume becomes smaller. When the reproduction volume is equal to or smaller than Pb, the control unit 22 sets the adjusting amount to the maximum value ADmax. Thus, the graph L has such a characteristic that the adjusting amount becomes larger as the reproduction volume becomes smaller and adjusting amount becomes smaller as the reproduction volume becomes larger. This is because, as the reproduction volume becomes smaller, the sound becomes more different from the sound intended by the sound creator, and hence it becomes necessary to increase the degree of adjustment. Inversely, this is because, as the reproduction volume becomes larger, the reproduced sound approaches the sound intended by the sound creator without the adjustment. The control unit 22 varies the adjustment amount of the spreading feeling by using the map indicating the relation of the graph of FIG. 10.

The map indicating the relation between the reproduction volume and the adjusting amount is not limited to the one indicating the relation of the graph L. In short, the map indicating the reproduction volume and the adjusting amount may be any map in which the adjusting amount becomes larger as the reproduction volume becomes smaller.

For example, in the graph L, the adjusting amount becomes the maximum value ADmax when the reproduction volume is equal to or smaller than Pb. However, it is limited to this, and the adjusting amount may be the maximum value ADmax when the reproduction volume becomes the minimum value Pmin. In the graph L, the adjusting amount becomes the minimum value ADmin when the reproduction volume becomes larger than Pa. However, it is not limited to this, and the adjusting amount may be the minimum value ADmin when the reproduction volume becomes the maximum value Pmax. Namely, the adjusting amount may be determined by using the map indicating the relation of the broken-line graphs La1 to La3 in FIG. 10. Further, the adjusting amount may be determined by using the map indicating the relation of the graph formed by plural straight lines of different slants, like the dashed-line graphs Na, Nb in FIG. 10. For example, the slant of the graph Na changes at (reproduction volume, adjusting amount)=(Pc, ADC). The slant of the graph

Nb changes at (reproduction volume, adjusting amount)=(Pd, ADd), (Pe, ADe), respectively. Further, the relation between the reproduction volume and the adjusting amount is not limited to the straight line graph like the graphs L, La1 to La3, Na, Nb, and may be indicated by the curved line graph such as the graphs Ma, Mb.

The control unit 22 varies the adjusting amount by using the map indicating the relation of the graph of FIG. 10. Therefore, it becomes possible to impressively present the sound to the user, irrespective of the volume with which the user actually listens to the sound.

The control unit 22 outputs the spreading feeling control signal Wct including the adjusting amount of the spreading feeling set by the above-described method to the spreading feeling adjusting unit 23 (See. FIG. 3). The spreading feeling adjusting unit 23 adjusts the spreading feeling in the left-right direction by applying the wide stereo processing or the reflected sound/reverberation sound adding processing, for example, to the audio signals SFL, SFR, SSL, SSR, SSBL, SSBR in accordance with the adjusting amount of the spreading feeling. Concretely, the spreading feeling adjusting unit 23 performs the adjustment such that the spreading feeling becomes larger as the adjusting amount of the spreading feeling becomes larger and the spreading feeling becomes smaller as the adjustment amount of the spreading feeling becomes smaller. For example, if the spreading feeling adjusting unit 23 applies the processing of adding the reverberation sound, it makes the degree of adding the reverberation sound larger as the adjustment amount of the spreading feeling becomes larger and makes the degree of adding the reverberation sound smaller as the adjustment amount of the spreading feeling becomes smaller. By this, the spreading feeling can be appropriately adjusted, and the sound can be impressively presented to the user.

Next, the description will be given of the adjusting method of the front-rear balance of the spreading feeling. The control unit 22 generates the front-rear balance control signal FBct, including the front-rear balance adjusting amount for adjusting the balance of the front-rear spreading feeling, based on the front-rear balance information FBinf, the signal level information SigLev and the volume level Volp, and outputs it to the spreading feeling adjusting unit 23. The spreading feeling adjusting unit 23 adjusts the audio signals SFL, SFR, SSL, SSR, SSBL, SSBR in accordance with the front-rear balance adjusting amount thereby to adjust the balance of the front-rear spreading feeling.

More specifically, the control unit 22 determines which one of the front audio signal and the rear audio signal has larger audio signal level, based on the front-rear balance information FBinf. Concretely, the control unit 22 determines that the front audio signal level is larger when the front-rear balance information FBinf is positive, and determines that the rear audio signal level is larger when the front-rear balance information FBinf is negative. Then, the control unit 22 sets the front-rear balance adjusting amount such that the adjusting amount of the spreading feeling for the audio signal having a larger level is larger than the adjusting amount of the spreading feeling for the audio signal having a smaller level. In addition, the control unit 22 sets the magnitude of the front-rear balance adjusting amount in accordance with the absolute value of the front-rear balance information FBinf. As the front-rear balance adjusting amount becomes larger, the difference of the adjusting amount of the spreading feeling between the front and the rear becomes larger.

Further, the control unit 22 varies the front-rear balance adjusting amount in accordance with, not only the front-rear balance information FBinf, but also the signal level information SigLev and the volume level Volp. Concretely, the control unit 22 varies the front-rear balance adjusting amount in accordance with the reproduction volume calculated by multiplying the signal level of the audio signals S by the volume level Volp, by using the relation of the graph described above and shown in FIG. 10.

The control unit 22 outputs the front-rear balance control signal FBct including the front-rear balance adjusting amount set by the above-described method to the spreading feeling adjusting unit 23. The spreading feeling adjusting unit 23 adjusts the audio signals SFL, SFR, SSL, SSR, SSBL, SSBR thereby to adjust the balance of the front-rear spreading feeling. Concretely, in accordance with the front-rear balance adjusting amount, the spreading feeling adjusting unit 23 makes the adjusting amount of the front spreading feeling larger than the adjusting amount of the rear spreading feeling, or makes the adjusting amount of the rear spreading feeling larger than the adjusting amount of the front spreading feeling. For example, in the case of performing the processing of adding the reverberation sound, when the adjusting amount of the front spreading feeling is larger than the adjusting amount of the rear spreading feeling, the spreading feeling adjusting unit 23 performs the processing of making the adding degree of the reverberation sound to the front audio signals SFL, SFR larger than the adding degree of the reverberation sound to the rear audio signals SSL, SSR, SSBL, SSBR. When the adjusting amount of the rear spreading feeling is larger than the adjusting amount of the front spreading feeling, the spreading feeling adjusting unit 23 performs the processing of making the adding degree of the reverberation sound to the rear audio signals SSL, SSR, SSBL, SSBR larger than the adding degree of the reverberation sound to the front audio signals SFL, SFR.

Here, the spreading feeling adjusting unit 23 does not perform the adjustment for the center audio signal SC. Since the center audio signal SC is an audio signal of audio mainly including speech, the audio including the speech has the spreading feeling and the speech becomes difficult to listen, if the spreading feeling adjusting processing is applied.

By this, the balance of the front-rear spreading feeling can be appropriately adjusted, and the sound can be impressively presented to the user.

Next, the description will be given of the adjusting method of speech clearness. The control unit 22 generates the speech clearness control signal Cct including the adjusting amount of the speech clearness based on the speech rate information CXinf, the signal level information SigLev and the volume level Volp, and outputs it to the speech clearness adjusting unit 24. The speech clearness adjusting unit 24 adjusts the center audio signal SC in accordance with the adjusting amount of the speech clearness thereby to adjust the speech clearness.

More specifically, the control unit 22 calculates the rate of the speech and the audio other than speech, based on the speech rate information CXinf, and sets the adjusting amount of the speech clearness in accordance with the balance of the speech and the audio other than speech. For example, the control unit 22 increases the adjusting amount of the speech clearness in accordance with the rate of the speech, when the rate of the speech is larger than the rate of the audio other than speech. Instead of this, the control unit 22 may determine the presence/absence of the speech from the relation between the rate of the speech and the rate of the audio other than speech. For example, the control unit 22 determines that the speech exists when it determines that the rate of the speech is equal to or larger than a predetermined value. When the control unit 22 determines that the speech exists, it sets a predetermined adjusting amount of the speech clearness. When the control unit 22 determines that the speech does not exist, it sets the adjusting amount of the speech clearness to be a minimum value and does not perform the adjustment.

Here, the control unit 22 varies the adjusting amount of the speech clearness in accordance with, not only the speech rate information CXinf, but also the signal level information SigLev and the volume level Volp. Concretely, the control unit 22 varies the adjusting amount of the speech clearness in accordance with the reproduction volume calculated by multiply the signal level of the audio signal S by the volume level Volp, by using the relation of the graph described above and shown in FIG. 10.

The control unit 22 outputs the speech clearness control signal Cct including the adjusting amount of the speech clearness set by the above-described method to the speech clearness adjusting unit 24. The speech clearness adjusting unit 24 adjusts the speech clearness by adjusting the level of the center audio signal SC at the frequency band corresponding to the formant frequency, for example, or by equalizing the center audio signal SC, in accordance with the adjusting amount of the speech clearness.

Concretely, the speech clearness adjusting unit 24 performs the adjustment to make the speech clearness higher as the adjusting amount of the speech clearness becomes larger, and performs the adjustment to make the speech clearness lower as the adjustment amount of the speech clearness becomes smaller. For example, in performing the processing of adjusting the level of frequency band corresponding to the formant frequency, the speech clearness adjusting unit 24 makes the adjusting amount of the level of the frequency band corresponding to the formant frequency larger as the adjusting amount of the speech clearness becomes larger, and makes the adjusting amount of the level of the frequency band corresponding to the formant frequency smaller as the adjusting amount of the speech clearness becomes smaller. By this, the speech can be appropriately clarified, and the sound can be impressively present to the user.

Next, the description will be given of the adjusting method of bass volume feeling. The control unit 22 generates the bass volume feeling control signal LWSct including the adjusting amount of the bass volume feeling, based on the spreading degree information Winf, the signal level information SigLev and the volume level Volp, and outputs it to the bass volume feeling adjusting unit 25. The bass volume feeling adjusting unit 25 adjusts the audio signals in accordance with the adjusting amount of the bass volume feeling, thereby to adjust the bass volume feeling.

More specifically, based on the spreading degree information Winf, the control unit 22 sets the adjusting amount of the bass volume feeling to be smaller as the spreading degree is smaller, and sets the adjusting amount of the bass volume feeling to be larger as the spreading degree is larger. This is because, if the spreading degree is small, it is highly possible that the speech is being outputted, and the speech becomes difficult to listen if the adjusting amount of the bass volume feeling is increased. On the contrary, when the spreading degree is large, it is highly possible that the scene is powerful, and it is necessary to increase the powerfulness by increasing the adjusting amount of the bass volume feeling.

Here, the control unit 22 varies the adjusting amount of the bass volume feeling in accordance with, not only the spreading degree information Winf, but also the signal level information SigLev and the volume level Volp. Concretely, the control unit 22 varies the adjusting amount of the bass volume feeling in accordance with the reproduction volume calculated by multiplying the signal level of the audio signal S by the volume level Volp, by using the relation of the graph described above and shown in FIG. 10.

The control unit 22 outputs the bass volume feeling control signal LWSct including the adjusting amount of the bass volume feeling set by the above-described method to the bass volume feeling adjusting unit 25. The bass volume feeling adjusting unit 25 adjusts the bass volume feeling by adjusting the level of the audio signals S at the frequency band corresponding to the bass or by equalizing the audio signals S, in accordance with the adjusting amount of the bass volume feeling. Concretely, the bass volume feeling adjusting unit 25 performs the adjustment to make the bass volume feeling larger as the adjusting amount of the bass volume feeling becomes larger, and performs the adjustment to make the bass volume feeling smaller as the adjusting amount of the bass volume feeling becomes smaller. For example, in performing the processing of adjusting the level of the frequency band corresponding to bass, the bass volume feeling adjusting unit 25 makes the adjusting amount of the level of the frequency band corresponding to bass to be larger as the adjusting amount of the bass volume feeling becomes larger, and makes the adjusting amount of the level of the frequency band corresponding to bass to be smaller as the adjusting amount of the bass volume feeling becomes smaller. By this, the bass volume feeling can be appropriately adjusted, and the sound can be impressively presented to the user. It is noted that the control unit 22 may adjust the treble sound in the similar manner so as to maintain its balance with the bass sound.

As described above, according to the first embodiment, the audio signals S are adjusted in terms of the spreading feeling, the speech clearness and the bass volume feeling based on the analysis information analyzed by the audio analyzing unit 21 and the volume level. By this, the sound expressed by the sound creator can be impressively presented to the user, and presence can be created. Particularly, by varying the adjusting amount based on the signal level of the audio signals S and the volume level, the sound can be impressively presented to the user, irrespective of the volume with which the user actually listens to the sound.

### 2nd Embodiment

Next, the audio adjusting device according to the second embodiment will be described. In the cases where the user's listening environment is bright and dark, the sound audible to the user at the time that the reproduction volume is relatively small and/or the localization feeling may be different. Therefore, in the audio adjusting device according to the second embodiment, the adjustment of the audio signal is performed in accordance with the listening environment of the user.

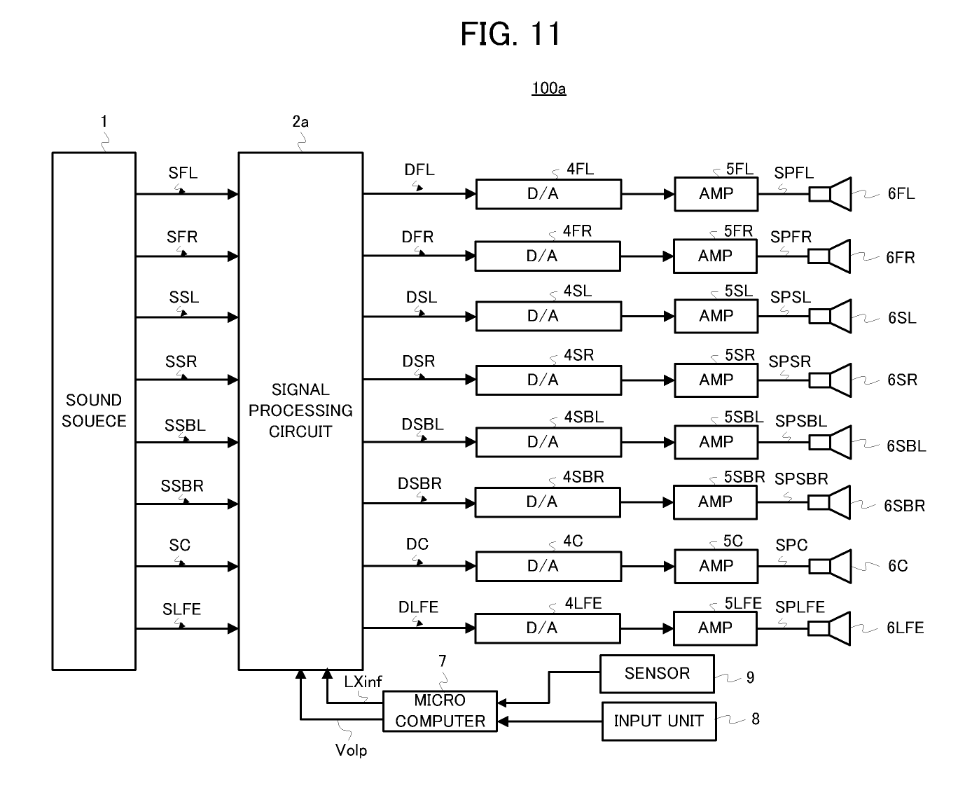

FIG. 11 is a block diagram illustrating the audio system including the audio adjusting device according to the second embodiment.

The audio system 100a illustrated in FIG. 11 is different from the audio system 100 illustrated in FIG. 1 in that it has the signal processing circuit 2a instead of the signal processing circuit 2 and it further has the illumination sensor 9 connected to the microcomputer 7.

The illumination sensor 9 is arranged outside of the AV amplifier including the signal processing circuit 2a, and detects the surrounding brightness (illumination), e.g., the brightness of the listening room 10 (see. FIG .2) where the user is present. The microcomputer 7 transmits the illumination information LXinf indicating the illumination detected by the illumination sensor 9 to the signal processing circuit 2a.

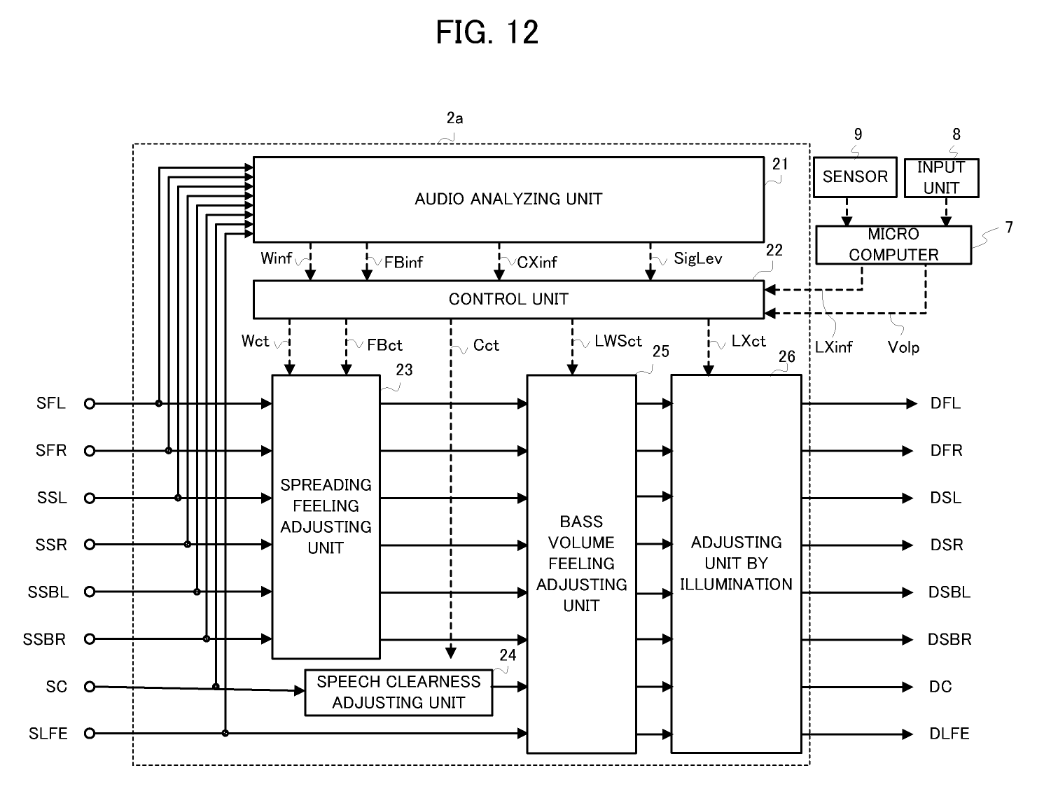

The configuration of the signal processing circuit 2a will be described with reference to FIG. 12. FIG. 12 is a block diagram illustrating the configuration of the signal processing circuit 2a. In FIG. 12, the audio signals are illustrated by the solid lines, and the signals other than the audio signals, e .g. the control signals, are illustrated by the broken lines. The signal processing circuit 2a illustrated in FIG. 12 includes an adjusting unit 26 by the illumination, in addition to the configuration of the signal processing circuit 2 illustrated in FIG. 3.

The control unit 22 generates the adjustment control signal LXct including the adjusting amount (adjusting amount by the illumination) for adjusting the signal level in accordance with the illumination, based on the illumination information LXinf, the signal level information SigLev and the volume level Volp, and outputs it to the adjusting unit 26 by the illumination. The adjusting unit 26 by the illumination adjusts the audio signals S in accordance with the adjusting amount by the illumination. As this adjusting processing, for example, it is possible to apply the processing of amplifying the entire frequency band of the audio signal S or amplifying only the level of the frequency band of relatively high range around as 8 kHz, in accordance with the adjusting amount by the illumination.

More specifically, based on the illumination information LXinf, the control unit 22 sets the adjusting amount by the illumination to be larger as the illumination is higher, and sets the adjusting amount by the illumination to be smaller as the illumination is lower. This is because, there is such an aural characteristic of human being that the sensitivity to small sound is higher in a dark place than in a bright place, i.e., small sound can be easily heard in a dark place.

Here, the control unit 22 varies the adjusting amount by the illumination in accordance with, not only the illumination information LXinf, but also the signal level information SigLev and the volume level Volp. Concretely, the control unit 22 varies the adjusting amount by the illumination in accordance with the reproduction volume calculated by multiplying the signal level of the audio signals by the volume level Volp, by using the relation of the graph described above and shown in FIG. 10.

The control unit 22 outputs the adjusting control signal LXct including the adjusting amount by the illumination set by the above-described method to the adjusting unit 26 by the illumination. The adjusting unit 26 by the illumination makes the amplitude of the audio signals S larger as the adjusting amount by the illumination is larger, and makes the amplitude of the audio signals S smaller as the adjusting amount by the illumination is smaller.

As described above, according to the second embodiment, the audio signals S are adjusted based on the illumination of the environment detected by the illumination sensor, the signal level of the audio signals and the volume level. By this, the sound can be impressively presented to the user, irrespective of the brightness of the place where the user is present.

### 3rd Embodiment

Next, the audio adjusting device according to the third embodiment will be described. While the first and second embodiments are directed to the example in which the audio signals inputted from the audio source are multi-channel signals, the third embodiment is directed to the example in which the audio signals inputted from the audio source are 2-channel signals.

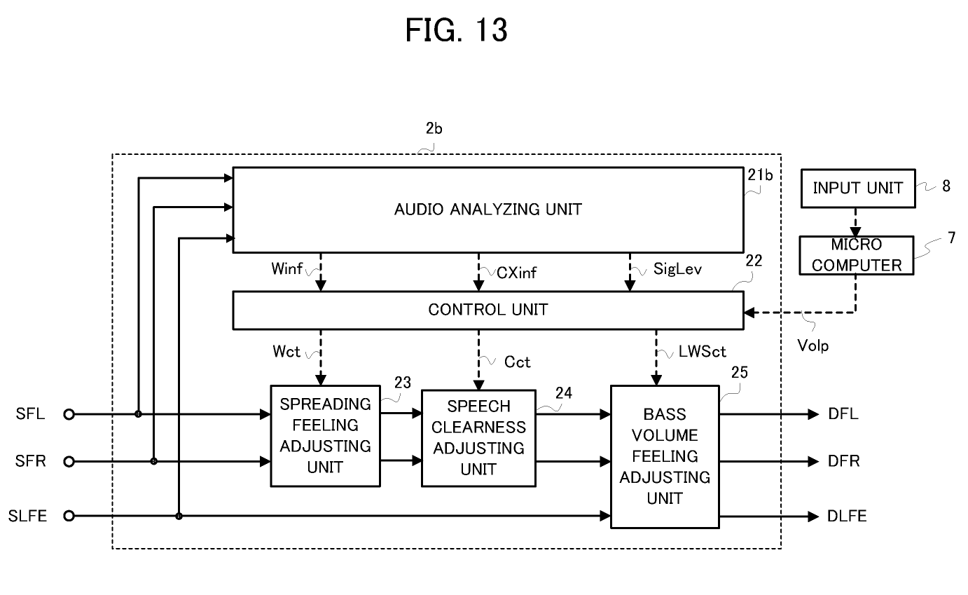

FIG. 13 is a block diagram illustrating the configuration of the signal processing circuit 2b. In FIG. 13, the audio signals are shown by the solid lines, and the signals other than the audio signals, such as the control signals, are shown by the broken lines.

The audio system including the audio adjusting device according to the third embodiment is different from the audio system 100 shown in FIG. 1 in that it includes the signal processing circuit 2b instead of the signal processing circuit 2, and the audio signals SFL, SFR, SLFE are inputted from the sound source 1 as the audio signals S as illustrated in FIG. 13. In addition, the signal processing circuit 2b is different from the signal processing circuit 2 shown in FIG. 3 in that it includes the audio analyzing unit 21b instead of the audio analyzing unit 21. Since there is no center audio signal in the third embodiment, the speech is transmitted by the left and right audio signals SFL, SFR.

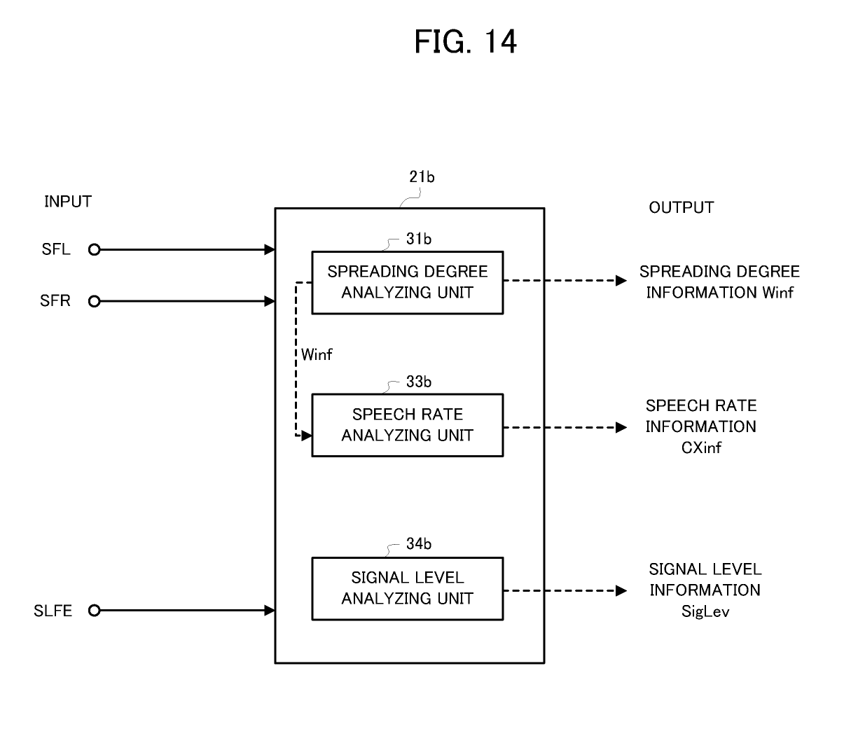

FIG. 14 is a block diagram illustrating the configuration of the audio analyzing unit 21b. The audio analyzing unit 21b includes the spreading degree analyzing unit 31b, the speech rate analyzing unit 33b and the signal level analyzing unit 34b. As illustrated in FIG. 14, the spreading degree analyzing unit 31b generates the spreading degree information Winf, the speech rate analyzing unit 33b generates the speech rate information CXinf, and the signal level analyzing unit 34b generates the signal level information SigLev.

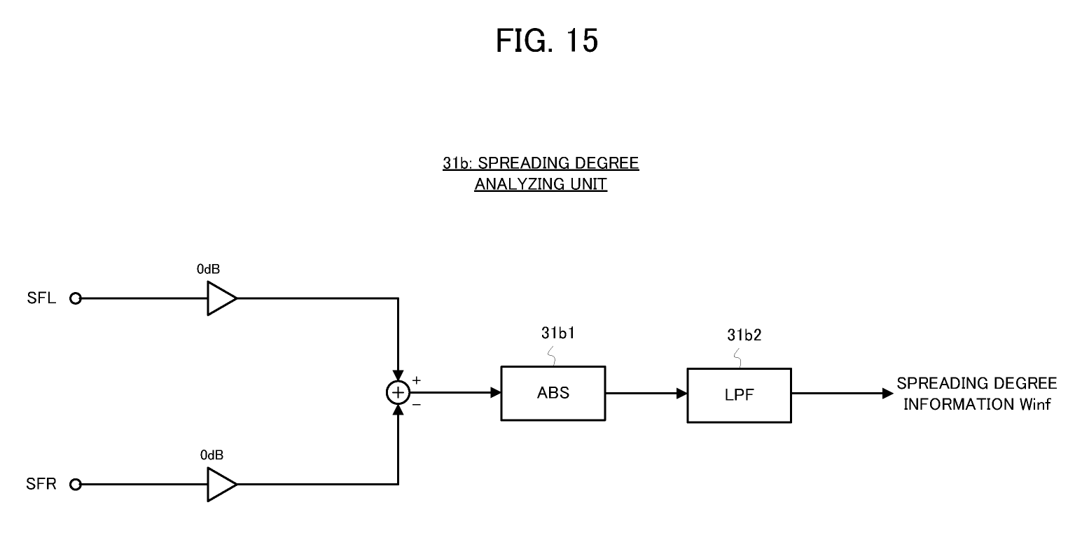

The spreading degree analyzing unit 31b will be described with reference to FIG. 15. FIG. 15 is a block diagram illustrating the configuration of the spreading degree analyzing unit 31b. Similarly to the first embodiment, the spreading degree analyzing unit 31b calculates the spreading degree information Winf based on the difference between the left audio signal SFL and the right audio signal SFR. Here, as illustrated in FIG. 15, the audio signal SFL and the audio signal SFR are equally weighted. In the example illustrated in FIG. 15, the audio signal SFL and the audio signal SFR are equally weighted by 0 dB. The spreading degree analyzing unit 31b generates the absolute value of the difference signal of the left audio signal SFL and the right audio signal SFR by the absolute value circuit 31b1. Then, the spreading degree analyzing unit 31b smoothes the absolute value of the difference signal by the low pass filter 31b2 to supply it to the control unit 22 as the spreading degree information Winf, and also outputs the spreading degree information Winf to the speech rate analyzing unit 33b.

Returning to FIG. 14, the speech rate analyzing unit 33b will be described. In the third embodiment, unlike the first embodiment, the speech rate analyzing unit 33b generates the speech rate information CXinf based on the spreading degree information Winf. Concretely, based on the spreading degree information Winf, the speech rate analyzing unit 33b calculates the rate of the speech and the audio other than speech such that the rate of speech is larger as the spreading degree is smaller and the rate of speech is smaller as the spreading degree is larger. Then, the speech rate analyzing unit 33b outputs the result thus calculated to the control unit 22 as the speech rate information CXinf. By this, the speech rate information CXinf can be calculated even in a case where there is no center audio signal and the speech is transmitted by the left and right audio signals SFL, SFR.

Similarly to the signal level analyzing unit 34 (see FIG. 9), the signal level analyzing unit 34b generates the absolute value of the audio signals SFL, SFR, respectively, by the absolute value circuit. Then, the signal level analyzing unit 34b smoothes the maximum level signal of those absolute value audio signals by the low pass filter and outputs it to the control unit 22 as the signal level information SigLev indicating the signal level of the audio signals S.

Similarly to the first embodiment, the control unit 22 generates various control signals for adjusting the audio signals based on the various analysis information and the volume level Volp, and outputs them to the spreading feeling adjusting unit 23, the speech clearness adjusting unit 24 and the bass volume feeling adjusting unit 25.

First, the adjusting method of the spreading feeling will be described. The control unit 22 generates the spreading feeling control signal Wct for adjusting the spreading feeling of audio based on the spreading degree information Winf, the signal level information SigLev and the volume level Volp, and outputs it to the spreading feeling adjusting unit 23.

Concretely, similarly to the first embodiment, the control unit 22 sets the adjusting amount of the spreading feeling in accordance with the spreading degree information Winf, and varies the adjusting amount of the spreading feeling in accordance with the reproduction volume calculated by multiply the signal level of the audio signals S by the volume level Volp, by using the relation of the graph described above and shown in FIG. 10.

The control unit 22 outputs the spreading feeling control signal including the adjusting amount of the spreading feeling set by the above-described method to the spreading feeling adjusting unit 23. The spreading feeling adjusting unit 23 applies the wide stereo processing or the reflected sound/reverberation sound adding processing to the audio signals SFL, SFR in accordance with the adjusting amount of the spreading feeling, thereby to adjust the spreading feeling.

Next, the adjusting method of the speech clearness will be described. The control unit 22 generates the speech clearness control signal Cct for adjusting the speech clearness based on the speech rate information CXinf, the signal level information SigLev and the volume level Volp, and outputs it to the speech clearness adjusting unit 24.

Concretely, similarly to the first embodiment, the control unit 22 sets the adjusting amount of the speech clearness in accordance with the speech rate information CXinf, and varies the adjusting amount of the speech clearness in accordance with the reproduction volume calculated by multiplying the signal level of the audio signals S by the volume level Volp, by using the relation of the graph described above and shown in FIG. 10.

The control unit 22 outputs the speech clearness control signal Cct including the adjusting amount of the speech clearness set by the above-described method to the speech clearness adjusting unit 24. The speech clearness adjusting unit 24 adjusts the speech clearness by the processing of adjusting the level of the audio signals SFL, SFR at the frequency band corresponding to the formant frequency, for example, or equalizing the audio signals SFL, SFR, in accordance with the adjusting amount of the speech clearness.

Next, the adjusting method of the bass volume feeling will be described. The control unit 22 generates the bass volume control signal LWSct based on the spreading degree information Winf, the signal level information SigLev and the volume level Volp.

Concretely, similarly to the first embodiment, the control unit 22 sets the adjusting amount of the bass volume feeling in accordance with the spreading degree based on the spreading degree information Winf, and varies the adjusting amount of the bass volume feeling in accordance with the reproduction volume calculated by multiplying the signal level of the audio signals S by the volume level Volp, by using the relation of the graph described above and shown in FIG. 10.

The control unit 22 outputs the bass volume feeling control signal LWSct including the adjusting amount of the bass volume feeling set by the above-described method to the bass volume feeling adjusting unit 25. The bass volume feeling adjusting unit 25 adjusts the bass volume feeling by the processing of adjusting the level the audio signals SFL, SFR, SLFE at the frequency band corresponding to the bass range, or equalizing the audio signals SFL, SFR, SLFE, in accordance with the adjusting amount of the bass volume feeling.

As described above, similarly to the first embodiment, by the third embodiment, the sound can be impressively presented to the user by varying the adjusting amount based on the signal level of the audio signals S and the volume level Volp, irrespective of the volume with which the actual user listens to the sound. In addition, by the third embodiment, the speech rate information is calculated based on the spreading degree information, and the control signal is generated based on the signal level of the audio signals S, the volume level and the speech rate information. By this, even in a case where there is no center audio signal and the speech is transmitted by the left and right audio signals SFL, SFR, i.e., the audio signal is 2-channel for example, the adjusting unit can appropriately clarify the speech, and the sound can be impressively presented to the user.

### Application of 3rd Embodiment

The audio adjusting device according to an application of the third embodiment will be described.

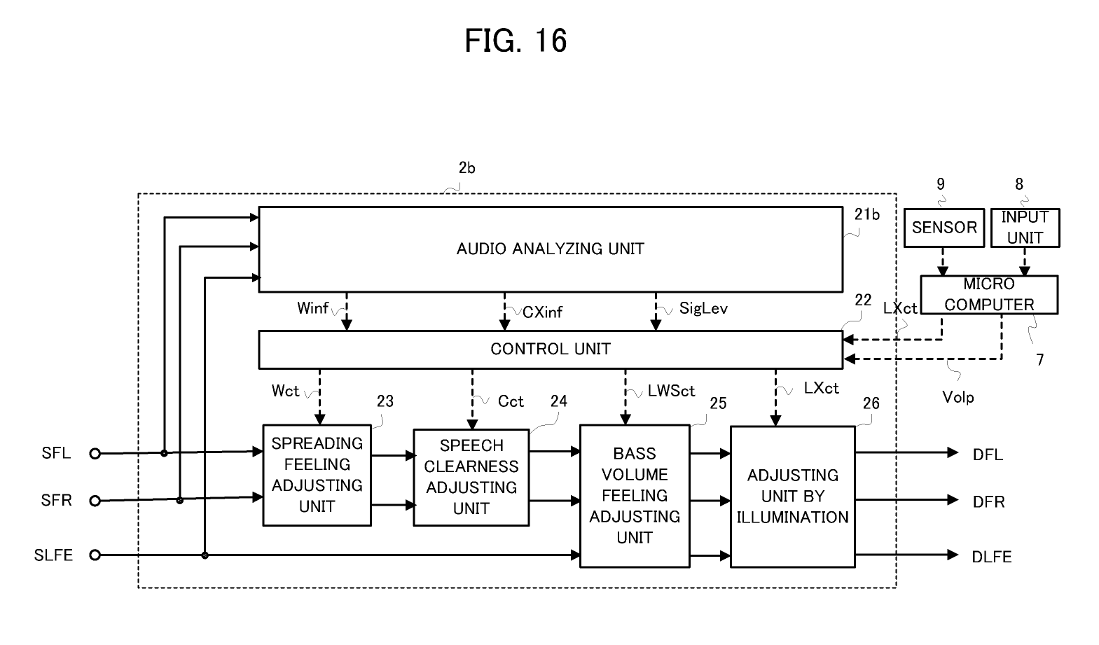

FIG. 16 is a block diagram illustrating the configuration of the signal processing circuit 2b according to the application of the third embodiment. In FIG. 16, the audio signals are shown by the solid lines, and the signals other than the audio signals are shown by the broken lines.

Similarly to the above-described second embodiment, in the application of the third embodiment, as is understood by FIG. 16, the audio system includes the illumination sensor 9 connected to the microcomputer 7, and the signal processing circuit 2b has the adjusting unit 26 by the illumination. Similarly to the above-described second embodiment, the microcomputer 7 transmits the illumination information LXinf indicating the illumination detected by the illumination sensor 9 to the signal processing circuit 2b.

The control unit 22 generates the adjusting control information LXct including the adjusting amount by the illumination based on the illumination information LXinf, the signal level information SigLev and the volume level Volp, and outputs it to the adjusting unit 26 by the illumination.

Concretely, similarly to the second embodiment, the control unit 22 sets the adjusting amount by the illumination in accordance with the illumination information LXinf, and varies the adjusting amount by the illumination in accordance with the reproduction volume calculated by multiplying the signal level of the audio signals S and the volume level Volp, by using the relation of the graph described above and shown in FIG. 10.

The control unit 22 outputs the adjusting control signal LXct including the adjusting amount by the illumination set by the above-described method to the adjusting unit 26 by the illumination. The adjusting unit 26 by the illumination adjusts the audio signals S in accordance with the adjusting control signal LXct by the illumination. This adjusting processing may be the processing of amplifying the level of whole frequency range of the audio signals S or amplifying only the level of the relatively high frequency range around 8 kHz, in accordance with the adjusting amount by the illumination.

By this, similarly to the second embodiment, the sound can be impressively presented to the user, irrespective of the brightness of the place where the user is listening to the sound.

### Modifications

In the first embodiment, the speech rate analyzing unit 33 calculates the speech rate information CXinf based on the center audio signal SC. However, the present invention is not limited to this. As described in the third embodiment, the speech rate information CXinf may be calculated based on the spreading degree information Winf.

In the above embodiments, each of the spreading feeling, the speech clearness and the bass volume feeling is adjusted, but the present invention is not limited to this. Needless to say, at least any one of them may be adjusted.

The present invention is not limited to the above-described embodiments, and may be changed or modified without departing from the gist or concept readable from the claims and specification. The audio adjusting device involving such change belongs to the technical range of the present invention.

### INDUSTRIAL APPLICABILITY

This invention can be used for an audio system such as an AV amplifier or a TV which supplies audio signals to multi-channel speakers to activate them.

1-7. (canceled)

8. An audio adjusting device comprising:
an audio analyzing unit which analyses audio based on inputted audio signals on a real time basis;
a control unit which generates control signals for adjusting the audio signals based on analysis information analyzed by the audio analyzing unit and a volume level instructed by a user; and
an adjusting unit which adjusts and outputs the audio signals based on the control signals in terms of at least one of spreading feeling, speech clearness and bass volume feeling,
wherein the control unit varies an adjusting amount of the audio signals based on a signal level of the audio signals and the volume level,
wherein the audio analyzing unit calculates spreading degree information indicating spreading degree of the audio in a left-right direction based on a difference between a sum signal of left audio signals and a sum signal of right audio signals, and
wherein the control unit generates the control signal for adjusting the audio signals based on the signal level of the audio signals, the volume level and the spreading degree information.

9. The audio adjusting device according to claim 8,
wherein the audio analyzing unit calculates front-rear balance information indicating a front-rear balance of the audio based on a difference between an average signal of absolute values of front audio signals and an average signal of absolute values of rear audio signals, and
wherein the control unit generates the control signal for adjusting the audio signals based on the signal level of the audio signals, the volume level and the front-rear balance information.

10. The audio adjusting device according to claim 8, wherein the audio analyzing unit calculates speech rate information indicating a rate of speech in the audio, based on a level of a center audio signal at each frequency band, and
wherein the control unit generates the control signal for adjusting the audio signals based on the signal level, the volume level and the speech rate information.

11. The audio adjusting device according to claim 8,
wherein the audio analyzing unit calculates speech rate information indicating a rate of speech based on the spreading degree information, and
wherein the control unit generates the control signal for adjusting the audio signals based on the signal level of the audio signals, the volume level and the speech rate information.
